(19) United States
(12) Patent Application Publication
(10) Pub. No.: US 2024/0062042 A1
(43) Pub. Date: Feb. 22, 2024

(54) HARDENING A DEEP NEURAL NETWORK AGAINST ADVERSARIAL ATTACKS USING A STOCHASTIC ENSEMBLE

(71) Applicant: SRI International, Menlo Park, CA (US)

(72) Inventors: Aswin Nadamuni Raghavan, Princeton, NJ (US); Saurabh Farkya, Princeton, NJ (US); Jesse Albert Hostetler, Boulder, CO (US); Avraham Joshua Ziskind, Cherry Hill, NJ (US); Michael Piacentino, Robbinsville, NJ (US); Ajay Divakaran, Monmouth Junction, NJ (US); Zhengyu Chen, Redwood City, CA (US)

(21) Appl. No.: 18/451,692

(22) Filed: Aug. 17, 2023

Related U.S. Application Data
(60) Provisional application No. 63/371,703, filed on Aug. 17, 2022.

(51) Int. Cl. G06N 3/045; G06F 21/56; G06N 3/098

(52) U.S. Cl. CPC G06N 3/045; G06F 21/566; G06N 3/098; G06F 2221/033

(57) ABSTRACT

In general, the disclosure describes techniques for implementing an MI-based attack detector. In an example, a method includes training a neural network using training data, applying stochastic quantization to one or more layers of the neural network, generating, using the trained neural network, an ensemble of neural networks having a plurality of quantized members, wherein at least one of weights or activations of each of the plurality of quantized members have different bit precision, and combining predictions of the plurality of quantized members of the ensemble to detect one or more adversarial attacks and/or determine performance of the ensemble of neural networks.

This application claims the benefit of U.S. Patent Application No. 63/371,703, filed Aug. 17, 2022, which is incorporated by reference herein in its entirety.

### GOVERNMENT RIGHTS

This invention was made with Government support under contract no. HR0011-19-9-0078 and contract no. HR0011-20-C-0011 awarded by the Defense Advanced Research Projects Agency. The Government has certain rights in this invention.

### TECHNICAL FIELD

This disclosure is related to machine learning systems, and more specifically to hardening a deep neural network (DNN) against adversarial attacks using a stochastic ensemble.

### BACKGROUND

Deep Learning (DL) involves training a DNN model with training data to produce a trained model able to generalize properties of data based on similar patterns with the training data. Training the model often involves learning model parameters by optimizing an objective function. For some applications, in addition to minimizing the objective function, a trained model may need to satisfy additional properties.

DL models deployed in uncontrolled environments may be subject to adversarial attacks. Adversarial attack is a general term commonly used to refer to a method to generate adversarial examples. An adversarial example is an input to a machine learning model that is purposely designed to cause a model to make a mistake in its predictions despite resembling a valid input to a human. Despite active research on adversarial attacks and defenses, robustness of machine learning and deep learning models to adversarial attacks still remains an unsolved problem.

### SUMMARY

In general, the disclosure describes techniques for training a set of diverse ensemble models using information theory. Deep ensembles are currently created by one of the following methods: training a number of Deep Neural Networks (DNNs) in parallel from different random initialization of parameters, randomized smoothing that adds noise and smoothing to DNN inputs alone, ensemble generators that train a hypernetwork that then subsequently generate DNNs, or Bayesian DNNs that model the posterior distribution over weights. In contrast to conventional approaches, the techniques disclosed herein involve training a single DNN, but sampling as many DNNs as needed to make ensembles of arbitrary size. Diversity of the sampled ensembled is quantified and optimized during training in a theoretically justified manner. In an aspect, noise may be added to two (or more) DNN layer outputs and/or DNN weights beyond the input layer. Since this approach involves training only one first DNN and sampling multiple DNNs from the first DNN, there is no need to generate different weights of any fixed sized DNN ensemble. The disclosed diverse ensemble models are found to be nevertheless robust to adversarial perturbations and corruptions by an external attacker.

An ensemble learning problem may be formulated as learning a DNN such that a diverse and performant ensemble may be sampled by applying stochastic quantization (SQ) to one or more of its layers' inputs, outputs, and/or weights. For the training phase (also referred to as a learning problem/training), a family of quantization functions can be designed for quantization of inputs, weights and/or activations/outputs of one or more layers of the DNN, and may be set to provide a learned quantized value within a learned range, or a quantized value within a fixed range, e.g., either +1 or −1. Since the ensemble members are quantized DNNs, these members benefit from reduced computational complexity, which addresses the computational challenge of running large ensembles on constrained hardware.

The disclosed method can be run on a variety of standard hardware platforms. However, high-performance Graphics Processing Units (GPUs) may enhance the speed and performance of the neural hardening system. The hardened model output may be tailored to hardware of various footprints, from high-end GPU servers to low Size, Weight, and Power (SWaP) edge devices. In other words, the disclosed method is highly scalable (both in terms of hardware SWaP, training time and memory requirements) while being theoretically grounded in information theory and rate—distortion theory.

The techniques may provide one or more technical advantages that realize at least one practical application. For example, during the training phase, training the exemplary model without any assumptions on the threat model for the generation of adversarial attack examples may generalize the model to novel adversarial attacks generated from the test set. In some aspects, a unified analysis of different adversarial attacks on different DNNs and different datasets may be performed by correlating the change in Mutual Information (MI) values and accuracy. Other advantages may include, but are not limited to, enabling identification of worst-case vulnerabilities of any given DNN to attacks; increased robustness of ensembles to adversarial attacks; increased SWaP efficiency of ensemble of DNNs; enabling comparison of potency of different attack types; or enabling detection of adversarial attacks using MI.

In an example, a method includes, training a neural network using training data, applying stochastic quantization to one or more layers of the neural network, generating, using the trained neural network, an ensemble of neural networks having a plurality of quantized members, wherein at least one of weights or activations of each of the plurality of quantized members have different bit precision, and combining predictions of the plurality of quantized members of the ensemble to detect one or more adversarial attacks and/or determine performance of the ensemble of neural networks.

In an example, a computing system comprises: an input device configured to receive training data; processing circuitry and memory for executing a machine learning system, wherein the machine learning system is configured to: train a neural network using the training data, apply stochastic quantization to one or more layers of the neural network, generate, using the trained neural network, an ensemble of neural networks having a plurality of quantized members, wherein at least one of weights or activations of each of the plurality of quantized members have different bit precision, and combine predictions of the plurality of quantized members of the ensemble to detect one or more adversarial attacks and/or determine performance of the ensemble of neural networks.

In an example, non-transitory computer-readable media comprises machine readable instructions for configuring processing circuitry to: train a neural network using the training data, apply stochastic quantization to one or more layers of the neural network, generate, using the trained neural network, an ensemble of neural networks having a plurality of quantized members, wherein at least one of weights or activations of each of the plurality of quantized members have different bit precision, and combine predictions of the plurality of quantized members of the ensemble to detect one or more adversarial attacks and/or determine performance of the ensemble of neural networks.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example system in accordance with the techniques of the disclosure.

FIG. 2 is a block diagram of an example system that can aggregate data in a federated learning environment, according to techniques of this disclosure.

FIG. 3 is a diagram illustrating binary stochastic quantization, according to techniques of this disclosure.

FIG. 4 is a diagram illustrating unbiased stochastic quantization for nine bins, according to techniques of this disclosure.

FIG. 5 is a diagram illustrating controlled sparsity and variance of the stochastic quantization, according to techniques of this disclosure.

FIG. 6 is a block diagram of an ensemble generation architecture using stochastic quantization, according to techniques of this disclosure.

FIG. 7 is a flowchart illustrating an example mode of operation for a machine learning system, according to techniques described in this disclosure.

Like reference characters refer to like elements throughout the figures and description.

### DETAILED DESCRIPTION

Deep ensembles are conventionally created by (a) training a number of DNNs in parallel, (b) randomized smoothing that adds noise and smoothing to DNN inputs alone, (c) ensemble generators that train a hypernetwork that then subsequently generates DNNs, (d) Bayesian DNNs that model the posterior distribution over weights. Training a number of DNNs in parallel means that multiple neural networks may be trained on the same dataset, but with different random initializations. The different neural networks may then have different weights, and as a result, they may make different predictions on new data. The ensemble's uncertainty estimate may then be calculated by taking the average of the predictions of the individual networks.

Randomized smoothing is a different method for hardening in deep learning models. Randomized smoothing works by adding noise to the inputs of the DNN networks before making a prediction. This noise may help to regularize the DNN networks and make the DNN networks more robust to overfitting.

Ensemble generators is a more recent approach to creating deep ensembles. Ensemble generators approach may train a hypernetwork that can generate different DNNs. The hypernetwork may be trained on a dataset of DNN architectures, The hypernetwork may then be used to generate new DNNs for a specific task. This approach has the advantage of being able to create ensembles of DNNs with different architectures, which can lead to better uncertainty estimates.

Bayesian DNNs is a yet another way of modeling uncertainty in deep learning models. Bayesian DNNs may assume that the weights of the DNN are not fixed, but rather follow a probability distribution. Such assumption may allow the DNN to represent uncertainty about its predictions. However, Bayesian DNNs may be more computationally expensive to train than traditional DNNs.

In contrast to conventional approaches described above, aspects of the present disclosure contemplate training a single DNN and then applying stochastic quantization, described in greater detail below, to one (or more) DNN layers beyond the input layer. By repeating this step multiple times, the disclosed technique may generate a diverse set of DNNs that may be combined as an ensemble.

The ensemble may have better performance than a single DNN because it is more robust to adversarial attacks.

Advantageously, it may not be necessary to generate ensemble members with different weights and it may be sufficient to generate only one DNN that adds different noise to the ensemble member input, and/or inputs/outputs of one or more intermediate layers of the ensemble member DNN. It should be noted that at least in some cases, neural network hardening may produce theoretical guarantees about the worst-case performance of the network under attack. For example, in an aspect, adversarial training may be used to train a neural network to be robust to a specific type of adversarial attack. In this case, the theoretical guarantee is that the network will not be fooled by any adversarial examples of that type, no matter how carefully they are crafted. In an aspect, the worst-case performance of a DNN may be bounded by the performance of an ensemble of DNNs generated using stochastic quantization.

SQ is a technique that may be used to reduce the size and complexity of DNN while maintaining its accuracy. Stochastic quantization may be performed by randomly quantizing the weights or activations of the network to lower bit precision. In an aspect of the present disclosure, use of stochastic quantization to generate an ensemble of DNNs may be performed by training a single DNN such that randomly quantizing the weights or activations of the DNN to different bit precisions does not degrade (on average) the accuracy on the training data. As a result, a created ensemble may include a set of DNNs that are all trained on the same data but have different bit precisions. The diversity of the ensemble may be quantified using information theory. One measure of diversity is the mutual information between the inputs and outputs (e.g., of intermediate layers) of the different DNNs in the ensemble. A high mutual information indicates that the DNNs in the ensemble are similar, while a low mutual information indicates that they are diverse.

The Adversarial Information Plane (AIP) is a tool that may be used to understand adversarial attacks on DNNs. The term “AIP,” as used herein, refers to a two-dimensional plot of the accuracy of a DNN and the robustness of the DNN to adversarial attacks. The AIP may be used to visualize the trade-off between accuracy and robustness. AIP visualizations are typically created by plotting the model's accuracy on adversarial examples against the mutual information on said adversarial examples. In other words, an adversarial attack detector model disclosed herein may use the AIP to identify DNNs that are more robust to adversarial attacks. Furthermore, such adversarial attack detector model may be configured to identify DNNs that have been attacked by an adversarial example.

The present disclosure describes techniques for training diverse ensembles using information theory. The techniques include training a single DNN using an original dataset. Next, the weights and/or activations of the DNN are stochastically quantized to different bit precisions. Such quantization may be done using a variety of stochastic quantization methods. Each quantized DNN may be trained on the same dataset using the same training parameters that were used to train the original DNN. After training each quantized DNN, the MI between the inputs and outputs of the different quantized DNNs may be estimated using any information theory metric, such as, but not limited to, Kullback-Leibler divergence. In an aspect, the quantized DNNs with the lowest MI may be selected. These DNNs will be the most diverse and will therefore be more robust to adversarial attacks. An ensemble of the selected quantized DNNs may be further trained using any ensemble learning method. The disclosed approach is fast and efficient, effective, and versatile. More specifically, the quantized DNNs may be trained on the same dataset as the original DNN, and the MI between the inputs and outputs of the quantized DNNs may be estimated quickly. The ensembles of quantized DNNs that are trained using the disclosed approach are more robust to different types of adversarial attacks than single DNNs while not using any adversarial examples for training. Further, the disclosed approach may be used for adversarial training of ensembles of quantized DNNs on any dataset and for any type of adversarial attack.

In addition, this disclosure describes an ensembling approach that applies information-theoretic regularization to ensure that the ensembles are diverse and robust to attacks. For example, the techniques may include regularization via a MI penalty. MI is a measure of the shared information between two random variables. In the context of DNNs, MI can be used to measure the similarity between the outputs of different ensemble members. The MI penalty encourages the ensemble members to be diverse, which can improve the robustness of the ensemble to adversarial attacks. The techniques described therein are effective at generating ensembles of DNNs that are more robust to adversarial attacks.

In one aspect, MI between the input and intermediate outputs (features) of a single DNN may be used to penalize overfitting. Minimizing this MI while simultaneously maximizing accuracy of the ensemble produces diverse and robust ensembles.

In addition, the empirical results for end-to-end ensemble training with diversity regularization and Lipschitz regularization show that the disclosed techniques may provide significant gains in robustness compared to vanilla DNNs without the use of adversarial training. The techniques may also provide modest gains when compared to ensemble-based defenses (ADP) and quantization-based defenses that do not use adversarial samples for training. The approach described in the disclosure enables visualization of the AIP. The AIP is a tool that can be used to visualize the robustness of different DNNs to different attacks. The AIP plots enable a unified analysis of different attacks on different DNNs and different datasets by correlating the change in MI values and accuracy. The AIP plots may be helpful for understanding the trade-off between robustness and accuracy and for selecting the right DNN for a particular application.

Armed with the AIP, aspects of the present disclosure implement an MI-based attack detector. The attack detector may be configured to first calculate the MI between the inputs and the intermediate outputs (features) of a DNN ensemble member. This MI calculated and averaged on the training data is used to establish a threshold. Given a test image, the detector may then compute and compare the MI value to a threshold. If the absolute value of MI is above the threshold, the attack detector may predict that the input image is adversarial. Evaluation of the results produced by the MI-based attack detector on a variety of datasets and attacks indicate that the detector may effectively detect some adversarial attacks. However, such detector is not capable to detect all adversarial attacks. This is because some adversarial attacks can be designed to have a low MI value, which makes them difficult to detect using MI value alone.

The present disclosure describes techniques for training diverse ensembles using information theory. The techniques include training a single DNN using an original dataset. Next, noise from a prior distribution (e.g., gaussian distribution) may be added to the outputs of the penultimate layer of the DNN. A first set of MI between the input and noisy features is calculated for training data. A second set of MI between the input and noisy features is calculated for adversarial data, i.e., attacks crafted from the training set and using knowledge of the DNN. The training objective may include minimization of the first set of MI corresponding to clean data, and maximization of the second set of MI corresponding to the adversarial data. The disclosed approach is fast and efficient, effective, and versatile. The ensembles of quantized DNNs that are trained using the disclosed approach may be more robust to different types of adversarial attacks than single DNNs.

In summary, the techniques described herein include end-to-end training with MI and Lipschitz regularization that shows increased robustness to adversarial attacks.

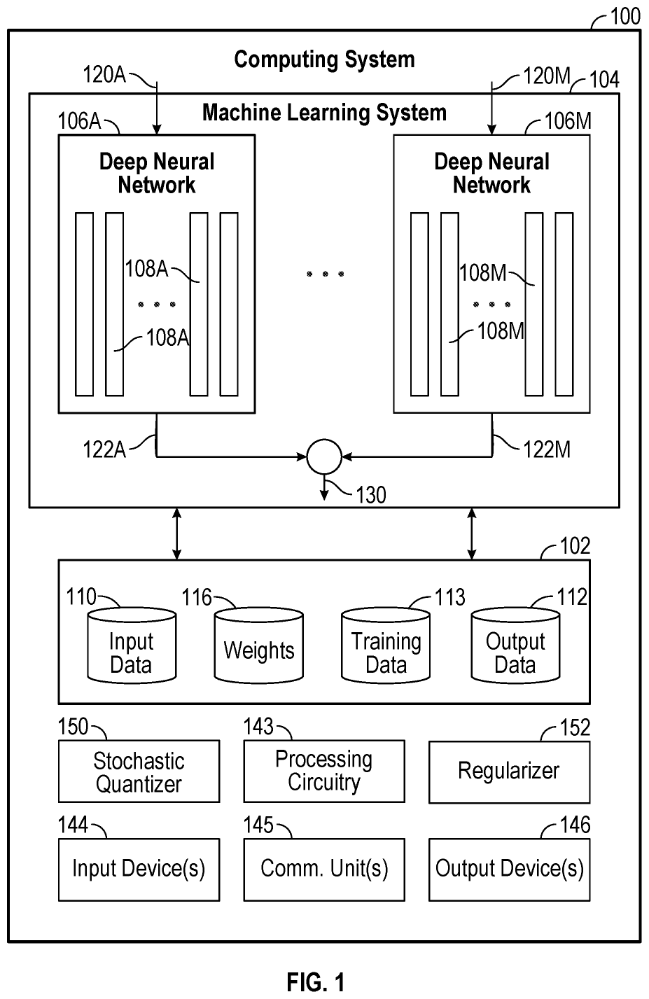

FIG. 1 is a block diagram illustrating an example computing system 100. As shown, computing system 100 comprises processing circuitry 143 and memory 102 for executing a machine learning system 104 having one or more deep neural networks (DNNs) 106A-106M (collectively, “DNNs 106”) comprising respective sets of layers 108A-108N (collectively, “layers 108”). Each of DNNs 106 may comprise various types of deep neural networks (DNNs), such as, but not limited to, recursive neural networks (RNNs) and convolutional neural networks (CNNs).

Computing system 100 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 100 may represent a cloud computing system, server farm, and/or server cluster (or portion thereof) that provides services to client devices and other devices or systems. In other examples, computing system 100 may represent or be implemented through one or more virtualized compute instances (e.g., virtual machines, containers, etc.) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 143 of computing system 100, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 100 comprises any suitable computing system having one or more computing devices, such as desktop computers, laptop computers, gaming consoles, smart televisions, handheld devices, tablets, mobile telephones, smartphones, etc. In some examples, at least a portion of system 100 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 102 may comprise one or more storage devices. One or more components of computing system 100 (e.g., processing circuitry 143, memory 102, stochastic quantizer 150, regularizer 152, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 143 of computing system 100 may implement functionality and/or execute instructions associated with computing system 100. Examples of processing circuitry 143 include microprocessors, application processors, display controllers, auxiliary processors, one or more sensor hubs, and any other hardware configured to function as a processor, a processing unit, or a processing device. Computing system 100 may use processing circuitry 143 to perform operations in accordance with one or more aspects of the present disclosure using software, hardware, firmware, or a mixture of hardware, software, and firmware residing in and/or executing at computing system 100. The one or more storage devices of memory 102 may be distributed among multiple devices.

Memory 102 may store information for processing during operation of computing system 100. In some examples, memory 102 comprises temporary memories, meaning that a primary purpose of the one or more storage devices of memory 102 is not long-term storage. Memory 102 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 102, in some examples, may also include one or more computer-readable storage media. Memory 102 may be configured to store larger amounts of information than volatile memory. Memory 102 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 102 may store program instructions and/or data associated with one or more of the modules described in accordance with one or more aspects of this disclosure.

Processing circuitry 143 and memory 102 may provide an operating environment or platform for one or more modules or units (e.g., stochastic quantizer 150, regularizer 152, etc.), which may be implemented as software, but may in some examples include any combination of hardware, firmware, and software. Processing circuitry 143 may execute instructions and the one or more storage devices, e.g., memory 102, may store instructions and/or data of one or more modules. The combination of processing circuitry 143 and memory 102 may retrieve, store, and/or execute the instructions and/or data of one or more applications, modules, or software. The processing circuitry 143 and/or memory 102 may also be operably coupled to one or more other software and/or hardware components, including, but not limited to, one or more of the components illustrated in FIG. 1.

Processing circuitry 143 may execute machine learning system 104 using virtualization modules, such as a virtual machine or container executing on underlying hardware. One or more of such modules may execute as one or more services of an operating system or computing platform. Aspects of machine learning system 104 may execute as one or more executable programs at an application layer of a computing platform.

One or more input devices 144 of computing system 100 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 146 may generate, transmit, or process output. Examples of output are tactile, audio, visual, and/or video output. Output devices 146 may include a display, sound card, video graphics adapter card, speaker, presence-sensitive screen, one or more USB interfaces, video and/or audio output interfaces, or any other type of device capable of generating tactile, audio, video, or other output. Output devices 146 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 100 may include a presence-sensitive display that may serve as a user interface device that operates both as one or more input devices 144 and one or more output devices 146.

One or more communication units 145 of computing system 100 may communicate with devices external to computing system 100 (or among separate computing devices of computing system 100) by transmitting and/or receiving data, and may operate, in some respects, as both an input device and an output device. In some examples, communication units 145 may communicate with other devices over a network. In other examples, communication units 145 may send and/or receive radio signals on a radio network such as a cellular radio network. Examples of communication units 145 include a network interface card (e.g., such as an Ethernet card), an optical transceiver, a radio frequency transceiver, a GPS receiver, or any other type of device that can send and/or receive information. Other examples of communication units 145 may include Bluetooth®, GPS, 3G, 4G, and Wi-Fi® radios found in mobile devices as well as Universal Serial Bus (USB) controllers and the like.

In the example of FIG. 1, DNNs 106 may receive input data from an input data set 110 and may generate output data 112. DNNs 106 may use an ensemble approach, in which output 130 is generated by combining outputs 122A-122M from respective DNNs 106. Input data 110 and output data 112 may contain various types of information. For example, input data 110 may include multimodal data. The term “multimodal data” or “multimodal information” is used herein to refer to information that may be composed of a plurality of media or data types such as, but not limited to, image data, video data, audio data, source text data, numerical data, speech data, and so on. Output data 112 may include classification data, translated text data, image classification data, robotic control data, transcription data, and so on.

Each set of layers 108 may include a respective set of artificial neurons. Layers 108A for example, may include an input layer, a feature layer, an output layer, and one or more hidden layers. Layers 108 may include fully connected layers, convolutional layers, pooling layers, and/or other types of layers. In a fully connected layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer.

Each input of each artificial neuron in each layer of the sets of layers 108 is associated with a corresponding weight in weights 116. The output of the k-th artificial neuron in DNN 106 may be defined as:

yₖ=ϕ(Wₖ·Xₖ) (1)

In Equation (1), yₖ is the output of the k-th artificial neuron, ϕ(·) is an activation function, Wₖ is a vector of weights for the k-th artificial neuron (e.g., weights in weights 116), and Xₖ is a vector of value of inputs to the k-th artificial neuron. In some examples, one or more of the inputs to the k-th artificial neuron is a bias term that is not an output value of another artificial neuron or based on source data. Various activation functions are known in the art, such as Rectified Linear Unit (ReLU), TanH, Sigmoid, and so on.

Machine learning system 104 may process training data 113 to train one or more of DNNs 105, in accordance with techniques described herein. For example, machine learning system 104 may apply an end-to-end training method that includes processing training data 113. Machine learning system 104 may use stochastic quantization to generate an ensemble of quantized DNNs 106 and may apply information-theoretic regularization to facilitate diverse ensembles of quantized DNNs 106 that are robust to attacks.

In an aspect, machine learning system 104 may also include stochastic quantization unit (stochastic quantizer) 150 to enable stochastic quantization for machine learning operations. The stochastic quantization unit 150 may be used to enable stochastic rounding during quantization operations. In an aspect, stochastic quantizer 150 may employ a type of quantization algorithm described below to select the quantization levels. In an aspect, stochastic quantizer 150 may help to improve the sparsity and low variance of the quantized weights. In an aspect, machine learning system 104 may additionally include regularizer 152. In an aspect, regularizer 152 may employ Lipschitz regularization which is a type of regularization that penalizes the network for having large changes in its output in response to small changes in its input. The Lipschitz regularizer 152 may help to prevent the network from becoming too sensitive to changes in the input data, which may make it more robust to adversarial attacks.

In traditional machine learning environments, training data is centrally held by one organization executing a machine learning algorithm. Distributed learning systems extend this approach by using a set of learning components accessing shared data or having the data sent to the participating parties from a central party, all of which are fully trusted. For example, one approach to distributed learning is for a trusted central party to coordinate distributed learning processes to a machine learning model. Federated learning systems extend this approach by using a set of learning components accessing data generated and stored locally on the device without transmitting and storing at a central component.

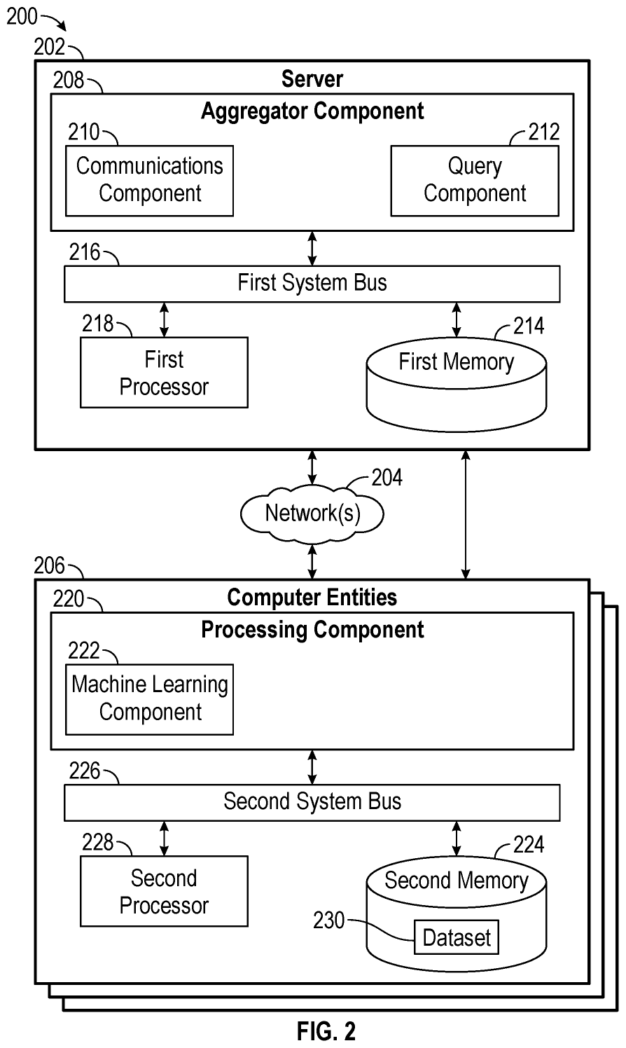

FIG. 2 is a block diagram of an example system 200 that can aggregate data in a federated learning environment, according to techniques of this disclosure.

As shown in FIG. 2, the system 200 may include one or more servers 202, one or more networks 204, and/or one or more computer entities 206. The server 202 may include aggregator component 208. The aggregator component 208 may further include communications component 210 and/or query component 212. Also, the server 202 may include or otherwise be associated with at least one first memories 214. The server 202 may further include a first system bus 216 that may couple to various components such as, but not limited to, the aggregator component 208 and associated components, first memory 214 and/or a first processor 218. While a server 202 is illustrated in FIG. 2, in other aspects, multiple devices of various types may be associated with or comprise the features shown in FIG. 2. Further, the server 202 may communicate with one or more cloud computing environments (e.g., via the one or more networks 204).

The one or more networks 204 may include wired and wireless networks, including, but not limited to, a cellular network, a wide area network (WAN) (e.g., the Internet) or a local area network (LAN). For example, the server 202 may communicate with the one or more computer entities 206 (and vice versa) using virtually any desired wired or wireless technology including for example, but not limited to: cellular, WAN, wireless fidelity (Wi-Fi), Wi-Max, WLAN, Bluetooth technology, a combination thereof, and/or the like. Further, although in the aspect shown the aggregator component 208 may be provided on the one or more servers 202, it should be appreciated that the architecture of system 200 is not so limited. For example, the aggregator component 208, or one or more components of aggregator component 208, may be located at another computer device, such as another server device, a client device, etc.

As shown in FIG. 2, the one or more computer entities 206 may include processing component 220. The processing component 220 may further include machine learning component 222. In an aspect, each machine learning component 222 may include an ensemble member (e.g., quantized DNN 106) shown in FIG. 1. Also, the one or more computer entities 206 may include or otherwise be associated with at least one second memories 224. The one or more computer entities 206 may further include a second system bus 226 that may couple to various components such as, but not limited to, the processing component 220 and associated components, second memory 224 and/or a second processor 228. Further, the server 202 may communicate with one or more cloud computing environments (e.g., via the one or more networks 204).

The system 200 may facilitate a federated learning environment in which the one or more computer entities 206 may be one or more parties participating in the federated learning environment. In various aspects, a user of the system 200 may enter (e.g., via the one or more networks 204) into the system 200 a machine learning algorithm. In one or more aspects, the aggregator component 208 may receive the machine learning algorithm (e.g., via the one or more networks 204) and execute the machine learning algorithm in conjunction with the one or more computer entities 206. For example, the aggregator component 208 may implement a data privacy scheme within the federated learning environment facilitated by the system 200 that may ensure privacy of computation, privacy of outputs, and/or trust amongst participating parties.

In one or more aspects, the communications component 210 may receive one or more inputs from a user of the system 200. For example, the communications component 210 may receive one or more machine learning algorithms. Further, the communications component 210 may share one or more of the inputs with various associated components of the aggregator component 208. In one or more aspects, the communications component 210 may also share the one or more inputs with the plurality of computer entities 206. For example, the communications component 210 may share a received machine learning algorithm, or a part of a machine learning algorithm, with the one or more computer entities 206.

In various embodiments, the aggregator component 208 may execute a received machine learning algorithm to generate a machine learning model, wherein the machine learning model may be trained based on data held by the one or more computer entities 206. For example, the query component 212 may generate one or more queries based on the received machine learning algorithm. For instance, each query may be a linear query requiring information from respective datasets 230 held and/or managed by the computer entities 206. In another aspect, a query may request the computation of gradients based on a provided initial model. The one or more queries may request information required by the machine learning algorithm for construction of the machine learning model. Further, the one or more queries generated by the query component 212 may be sent to the one or more computer entities 206 via the communications component 210 (e.g., through one or more secure channels of the one or more networks 204). For example, the query component 212 may generate a first query and/or a second query, wherein the first query may be sent to a first computer entity 206 and/or the second query may be sent to a second computer entity 206. The first query and the second query may be the same or different. Further, a plurality of queries may be generated by the query component 212 and sent by the communications component 210 to the same computer entity 206.

Each computer entity 206 comprised within the system 200 may include the processing component 220, which may receive one or more of the queries generated by the query component 212. Further, the one or more processing components 220 may include one or more machine learning components 222, as shown in FIG. 2. The one or more machine learning components 222 may generate one or more responses to the one or more received queries based on the dataset 230 respectively held and/or managed by the subject computer entity 206. For example, a first computer entity 206 may include a machine learning component 222 that may generate one or more responses based on a first dataset 230 held and/or managed by the first computer entity 206; while a second computer entity 206 may include another machine learning component 222 that may generate one or more other responses based on a second dataset 230 held and/or managed by the second computer entity 206. Further, the first dataset 230 and the second dataset 230 may comprise different training data. In various aspects, the one or more machine learning components 222 may generate the one or more responses in accordance with the machine learning algorithm or a portion of the machine learning algorithm.

In one or more embodiments, one or more of the computer entities 206 may be colluding parties and/or one or more of the computer entities 206 may be non-colluding parties. As used herein, the term “colluding parties” may refer to parties comprised within a federated learning environment that share data and/or information regarding data. For example, colluding parties may be co-owned by a governing entity and/or may be separate entities benefiting from cooperation towards a common goal. In contrast, as used herein the term “non-colluding parties” may refer to parties comprised within a federated learning environment that do not share data and/or information regarding data. For example, non-colluding parties may be interested in preserving the privacy of their respective data against disclosure to other parties participating in the federated learning environment. For example, one or more computer entities 206 may be non-colluding parties that hold and/or manage their respective datasets 230 privately without sharing the content of the datasets 230 with one or more other computer entities 206. In another example, one or more computer entities 206 may be colluding parties that share the content, or partial content, of their respective datasets 230 with other colluding computer entities 206.

As shown in FIG. 2, the datasets 230 may be stored within the second memories 224 of the computer entities 206. The data included within the datasets 230 may be used to train one or more machine learning models that may be synthesized by the aggregator component 208 based on the machine learning algorithm. To ensure privacy of the training data, the training data may remain stored within the datasets 230 and/or held and/or managed by the respective computer entities 206 throughout the various processes and/or computations of the system 200. Thereby, non-colluding parties within the federated learning environment may be unable to review, analyze, and/or manipulate the training data comprised within a dataset 230 not held and/or managed by the subject computer entity 206. For example, a first computer entity 206 may be unable to review, analyze, and/or manipulate the training data comprised within the dataset 230 of a second computer entity 206. Further, to ensure privacy of computation, the generation of responses may be performed privately by the one or more machine learning components 222. For example, a first computer entity 206 may be unable to review, analyze, and/or manipulate the one or more responses generated by the machine learning component 222 of a second computer entity 206. Thereby, for instance, the training data, computations, and/or generated responses performed by the computer entities 206 may be private from the other computer entities 206 within the federated learning environment. In another instance, a first computer entity 206 may share training data, computations, and/or generated responses with one or more colluding computer entities 206; whereas the first computer entity 206 may hold private training data, computations, and/or generated responses from non-colluding computer entities 206.

Each ensemble member may be executed and optimized on different edge devices and the weights of each ensemble member may be a stochastic quantization of the central neural network. In an aspect, such federated learning environment may allow for a certain degree of obfuscation as the weights may not be shared among the ensemble members. In an aspect, the disclosed quantization may guarantee a certain level of privacy.

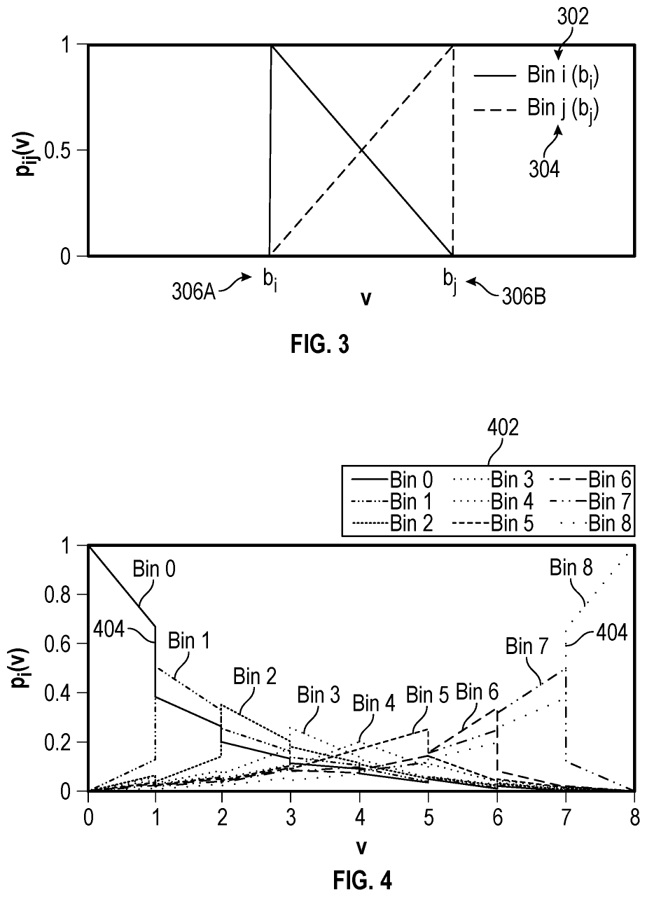

FIG. 3 is a diagram illustrating binary stochastic quantization, according to techniques of this disclosure. As noted above, quantization is the process of reducing the precision of the weights, biases, and activations of a neural network. Quantization may lead to a smaller and faster neural network, which may be important for mobile and embedded applications. Quantization may be used to accelerate both the inference and training of deep neural networks.

In an aspect, machine learning system 104 may employ quantization of activation functions of (DNNs) 106A-106M.

FIG. 3 illustrates relative probability 302 and 304 for 2 bins (bᵢ 302 and bⱼ 304), respectively. More specifically, a quantization function q: R→B may map a real number (R) to an element of an ordered set of values known as “bins” (B) 306A-B, B={bᵢ}, where each bᵢ∈R and bᵢ₊₁>bᵢ. In an aspect, bins 306A-B may be evenly spaced with δ=bᵢ₊₁−bᵢ. In SQ, the quantized value may be a random variable, q(v)˜p(v), with a categorical distribution p: R→Δ(B) supported on the bins. Differentiable sampling of q(v) allows training with standard gradient methods. In an aspect, differentiable sampling may be performed by using a technique called reparameterization.

Generally, the quantized value should be unbiased. In statistics, an unbiased estimator is an estimator whose expected value is equal to the true value of the parameter being estimated. In the context of quantization, this means that the expected value of the quantized value should be equal to the original, continuous value, which may be represented as:

Eₚ₍ᵥ₎[q(v)]=v (2)

However, extending an unbiased SQ scheme to an arbitrary number of bins may be problematic. For illustrative purposes only consider the binary SQ scheme shown in FIG. 3 and defined for values v∈[b₀, b₁] and given by:

$$q ( v ) = \{ \begin{matrix}{b}_{0} , & w . p . \frac{{b}_{1} - v}{{b}_{1} - {b}_{0}} \\ {b}_{1} , & w . p . \frac{v - {b}_{0}}{{b}_{1} - {b}_{0}}\end{matrix} \qquad ( 3 )$$

For distribution shown in FIG. 3, q(v) is unbiased for values in [b₀, b₁].

FIG. 4 is a diagram illustrating unbiased stochastic quantization for nine bins 402, according to techniques of this disclosure. The SQ scheme given by (3) may be extended to an arbitrary number of bins k as follows. Let p_{i,j}(v) denote the quantization probabilities as in Equation (3) for two bins bᵢ<bⱼ and pᵢ(v) denote the probability of mapping v to bᵢ,

$${p}_{i} ( v ) = \frac{1}{Z} {\tilde{P}}_{i} ( v ) ,$$

where \tilde{P}ᵢ(v)=Σ_{j:v∈[bi,bj]}p_{i,j}(v), and where the normalization constant is Z=Σₖ [symbol] (v). The normalization constant ensures that the total probability of a probability distribution is 1.

It should be noted that the stochastic quantization scheme is unbiased for any v∈[bᵢ, bₖ] because each pᵢⱼ(v) is unbiased and by linearity of expectation. The linearity of expectation states that the expected value of a sum of random variables is equal to the sum of the expected values of the random variables. This means that the expected value of the quantized value is equal to the sum of the probabilities of each bin multiplied by the value of the continuous value in that bin. If each pᵢⱼ(v) is unbiased, then the expected value of the quantized value is equal to the original, continuous value because the probability of each bin is proportional to the likelihood of the continuous value falling into that bin. However, as shown in FIG. 4, the aforementioned stochastic quantization scheme exhibits high sample variance and low sparsity caused by non-zero probabilities assigned to all bins, and discontinuities 404 at bin boundaries. A scheme with high sample variance is one where the data points are very spread out from the mean, and from one another. High sample variance may happen if the scheme assigns non-zero probabilities to all bins, and if there are discontinuities 304 at bin boundaries. Non-zero probabilities assigned to all bins means that there is a chance of the data point falling into any bin, no matter how unlikely. This makes the data points more spread out, because they are not all concentrated in a few bins. Discontinuities 404 at bin boundaries mean that the probability of the data point falling into a bin changes abruptly at the boundary between bins. Such discontinuities 404 prevent gradient estimation, differentiable sampling, and training by gradient descent. Low sparsity means that there are a lot of data points, relative to the number of bins, because the data points are more spread out and there is a chance of them falling into any bin.

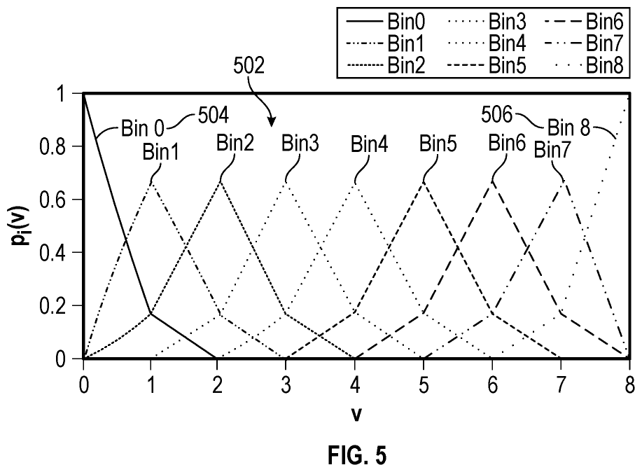

FIG. 5 is a diagram illustrating controlled sparsity and variance of the stochastic quantization, according to techniques of this disclosure. In an aspect, to address the problems illustrated in FIG. 4, a parameter α may be introduced that controls the sparsity and variance of SQ by limiting non-zero probabilities to bins that are at most α bins away from v. In other words, the probability of a data point falling into a bin is zero if the bin is more than α bins away from v. If α is small, then there may be few bins with non-zero probabilities, and the scheme may have high sparsity. If α is large, then there may be more bins with non-zero probabilities, and the scheme may have low sparsity. The variance of the scheme may also be controlled by adjusting α. If α is small, then the data points may be more concentrated around v, and the variance may be low. If α is large, then the data points may be more spread out around v, and the variance may be high.

In an aspect, the bin probabilities may be scaled as a function of distance normalized by the spacing between the bins. If the distance is small, then the probability of the data point falling into the bin may be high. If the distance is large, then the probability of the data point falling into the bin may be low. In an aspect, the normalized distance may be represented as:

$${δ}_{i} ( v ) \frac{\vert v - {b}_{i} \vert}{δ}$$

The probabilities of bᵢ and bⱼ may be weighted by

$$ρ ( 1 - \frac{\vert v - {b}_{i} \vert}{δ α} ) ,$$

where δ is the distance between bins, and p(t)=max (0, t). In an aspect, the quantization distribution may be defined by equation (4):

$${q}_{i , j} ( v ; α ) = \{ \begin{matrix}{b}_{i} , & w . p . \frac{{b}_{j} - x}{{b}_{j} - {b}_{i}} ρ ( 1 - \frac{{δ}_{i}}{α} ) ρ ( 1 - \frac{{δ}_{j}}{α} ) \\ {b}_{j} , & w . p . \frac{x - {b}_{i}}{{b}_{j} - {b}_{i}} ρ ( 1 - \frac{{δ}_{i}}{α} ) ρ ( 1 - \frac{{δ}_{j}}{α} )\end{matrix} \qquad ( 4 )$$

where

$${δ}_{k} = \frac{\vert v - {b}_{k} \vert}{δ}$$

and δ=b₂−b₁ is the bin spacing. The complexity of this efficient implementation is O(α²) because the number of bins with non-zero probability is O(α), and the softmax function may be evaluated in O(α²) time.

As shown in FIG. 5, the quantization distribution 502 defined by equation (4) results in probabilities free of discontinuities, with reduced variance compared to the approach illustrated in FIG. 4 due to distant bins 504, 506 having less influence. The probabilities may be differentiable with respect to α and v using the Gumbel-Softmax reparameterization for categorical distributions. The Gumbel-Softmax reparameterization for categorical distributions makes the probabilities differentiable with respect to the parameters a and v because the Gumbel-Softmax distribution is a smooth approximation to the categorical distribution, and so the gradients may be backpropagated through it. The softmax function may take a vector of real numbers and may output a vector of probabilities that sum to 1. The Gumbel distribution is a continuous distribution that is often used to add noise to a deterministic function.

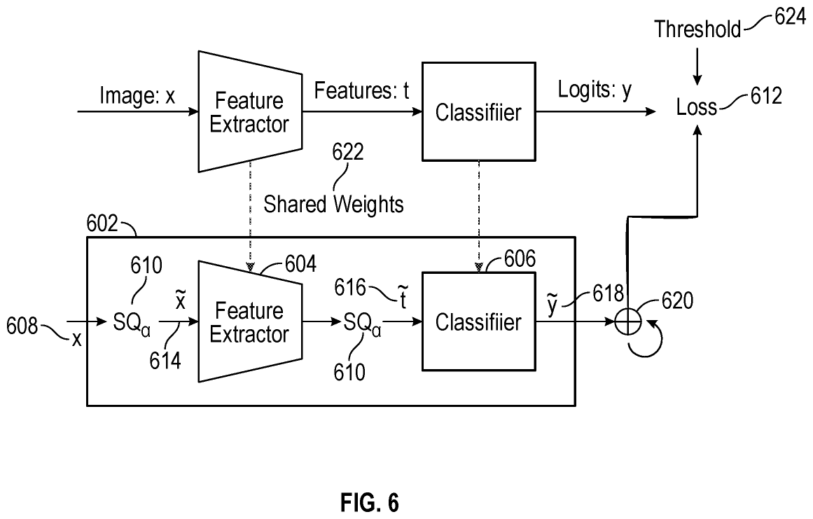

FIG. 6 is a block diagram of an ensemble generation architecture using stochastic quantization, according to techniques of this disclosure. In an aspect, the ensemble learning problem may be formulated as training a DNN f_{θ} such that a diverse and high-performance ensemble 602 is generated when SQ is applied to one or more DNN layers. As noted above, ensemble learning is a technique that combines the predictions of multiple models to improve the overall performance. In the case of DNNs, ensemble learning may be used to reduce the variance of the predictions and improve the generalization performance. SQ is a technique that randomly quantizes the weights 116 of a DNN, for example, during training. In an aspect, SQ may help to improve the generalization performance of the DNN, and it may also be used to generate a diverse ensemble of DNNs. The goal of the formulated ensemble learning problem is to find a DNN f_{θ} that is able to: generalize well to the test set; be diverse (the predictions of the different models in the ensemble should be different); have high performance (the ensemble should have a low error rate on the test set). Although the technique illustrated in FIG. 6 may be applied to any DNN architecture, for illustrative purpose, the description below makes a simplifying assumption that model 602 is an image classifier with distinct feature extractor and classifier stages. In other words, model 602 may be a type of image classifier that consists of two separate stages: a feature extractor 604 and a classifier 606. The feature extractor 604 may extract features from the input image x 608, and the classifier 606 may then classify the image x 608 based on the extracted features. The advantage of using a separate feature extractor 604 and classifier 606 is that such architecture allows the two stages to be optimized independently. The feature extractor 604 may be optimized to extract features that are relevant to the classification task, and the classifier 606 may be optimized to classify images based on the extracted features. The two stages may be implemented separately, which makes the classifier 606 easier to implement.

In an aspect, machine learning system 104 may apply SQ 610 to the input data (e.g., image x 608) to create a random variable \tilde{X} with a Probability Mass Function (PMF) p(\tilde{X}=x) using a quantization scheme defined by the equation (4). In an aspect, machine learning system 104 may apply SQ 610 to the image x 608 by randomly quantizing each pixel in the image. The random quantization noise creates a random variable \tilde{X} with PMF p(\tilde{X}=x). The PMF is the probability that the random variable \tilde{X} takes on the value x. The PMF is determined by the quantization scheme and the number of quantization levels. The goal of stochastic quantization is to find a quantization scheme and number of quantization levels that minimizes the loss of accuracy 612 while maximizing the diversity and reduction in precision. In an aspect, such goal may be achieved by empirically evaluating the performance of the model 602 on a validation dataset. Each ensemble member may forward-propagate a sample \tilde{x}˜p(\tilde{X}) 614 to obtain a different prediction 618.

Next, machine learning system 104 may apply SQ_{α} 610 to the output of the feature extractor 604 to reduce the precision of the feature representation without significantly impacting the accuracy of the classifier 606. In an aspect, machine learning system 104 may apply SQ_{α} 610 to the output of the feature extractor 604 by randomly quantizing each feature vector in the output of the feature extractor 604. The quantized feature representation is smaller and consumes less power than the original feature representation. Accordingly, quantized feature representation may be beneficial for mobile devices and other devices with limited resources. Furthermore, the quantization noise may help to regularize the classifier 606. The random quantization noise resulting from applying SQ_{α} 610 to the feature vector according to equation (4) may create a random variable \tilde{T} with PMF p(\tilde{T}|\tilde{X}=\tilde{x}). The PMF is the probability that the random variable \tilde{T} takes on the value \tilde{t}. The PMF is determined by the quantization scheme and the number of quantization levels. Each ensemble member may forward-propagate a sample \tilde{t}˜p(\tilde{T}|\tilde{X}=\tilde{x}) 616 through the corresponding classifier 606 to obtain a different prediction \tilde{y} 618. The predictions from the ensemble members are then combined 620 to obtain the final prediction.

In an aspect, a diverse and robust ensemble 602 may be trained using an information-theoretic approach to improve the generalization performance of the ensemble 602. The information-theoretic approach may be based on the idea that a diverse ensemble 602 is more likely to be sensitive to different attributes of the inputs, be robust to noise and outliers, and a robust ensemble 602 is more likely to generalize well to new data. The information-theoretic approach to training a diverse and robust ensemble 602 may involve measuring the diversity of the ensemble 602. The diversity of the ensemble 602 may be measured using information-theoretic measures such as, but not limited to, mutual information and entropy. These measures may be used to quantify the similarity between the predictions of the different ensemble members. The diversity of the ensemble 602 may be used to improve the interpretability of the predictions. In an aspect, the ensemble 602 may be trained to make the predictions of the different ensemble members as different as possible (maximize feature diversity), defined as the Shannon entropy H(\tilde{T}|\tilde{X}). The Shannon entropy is a measure of the uncertainty of the quantized output \tilde{T} given the input \tilde{X}. A high entropy means that the quantized output is diverse, and a low entropy means that the quantized output is identical across ensemble members.

The ensemble 602 may be trained to maximize the Shannon entropy by using a technique called entropy regularization. Entropy regularization may add a penalty to the loss function 612 that is proportional to the Shannon entropy of the predictions of the ensemble members. This penalty may encourage the ensemble members to make different predictions 618, which may increase the diversity of the ensemble 602. For example, entropy regularization may be used to train a diverse and robust ensemble 602 by first defining loss function 612 for the ensemble 602. The loss function 612 may be a measure of the accuracy of the ensemble 602. Then a penalty may be added to the loss function 612 that is proportional to the Shannon entropy of the predictions 618 of the ensemble members. Finally, machine learning system 104 may use the aforementioned gradient descent algorithm to adjust the parameters of the ensemble 602 to minimize the loss function 612. Such adjustment may include optimizing the entropy of the predictions of the ensemble members. In an aspect, the mutual information (MI) may be added to the usual cross entropy loss as a regularizer, defined by equation (5):

Min_{θ}L_{class}(θ)+βI(\tilde{X};\tilde{T}) (5)

MI is a measure of the dependence between two random variables. In the context of ensemble learning, MI may be used to measure the dependence between the predictions 518 of the different ensemble members. The MI between the two random variables \tilde{X} and \tilde{T} may defined as: I(\tilde{X}; \tilde{T})=H(\tilde{T})−H(\tilde{T}|\tilde{X}), where H(\tilde{T}) is the entropy of the quantized output \tilde{T} and where H(\tilde{T}|\tilde{X}) is the conditional entropy of the quantized output \tilde{T} given the quantized input \tilde{X}. In an aspect, the MI between \tilde{X} and \tilde{T} may be added to the usual cross-entropy loss by the regularizer 152. This means that the regularizer 152 may add MI to the loss function 612, and the parameters of the ensemble (e.g., shared weights 622) may then trained to minimize the total loss. In other words, the regularizer 152 may encourage the ensemble members to make predictions 618 that are different from each other. The regularizer 152 (such as MI regularizer) may help to improve the generalization performance of the ensemble 602, as the ensemble members may be less likely to make the same mistakes as each other. Advantageously, computing (\tilde{X}; \tilde{T}) is simple in the disclosed approach because the underlying random variables are quantized and discrete with known PMFs. The input distribution p(\tilde{x}) is the probability distribution of the quantized input x, and the feature distribution p(\tilde{T}|\tilde{x}) is the probability distribution of the quantized feature vector \tilde{T}. The input distribution and the feature distribution may be both important for the performance of the ensemble 602. In an aspect, MI may be calculated using the following equations (6), (7) and (8):

H(\tilde{T}ₗ)=−Σ_{\tilde{t}}_{ₗ}_{∈supp(\tilde{T}}_{ₗ}₎p(\tilde{T}ᵢ)log p(\tilde{T}ᵢ) (6)

H(\tilde{T}ᵢ|\tilde{X})=−Σ_{\tilde{x}˜\tilde{X}}p(\tilde{x})p(\tilde{T}ᵢ|\tilde{x})log p(\tilde{T}ᵢ|\tilde{x}) (7)

p(\tilde{T}ᵢ)=Σ_{\tilde{x}˜\tilde{X}}p(\tilde{T}ᵢ|\tilde{x})p(\tilde{x}) (8)

In an aspect, for multi-dimensional feature vectors, machine learning system 104 may calculate the MI per feature \tilde{T}ₗ and may average the MI over features and over batches of images. For example, n forward passes may be run with different \tilde{x}. These forward passes can be run concurrently in batches. MI estimates can converge quickly (e.g., n=128 samples for MNIST with 16 bins).

In an aspect, to achieve robust DNNs machine learning system 104 may enforce a small Lipschitz constant. Adversarial attacks that induce a bounded perturbation to the input may cause only a proportional change in the output. The Lipschitz constant of a DNN layer is the smallest C such that ∥f_{θ}(x)−f_{θ}(y)∥≤X∥x−y∥, ∀x, y. While the Lipschitz constant is typically hard to estimate, the nature of quantized ensemble 602 may allow to regularize with an easy to compute surrogate. The perturbation to the input is bounded by O(αδ_{X̅−}), where δ_{\tilde{x}} is the spacing between bins of SQ 610 of the input layer. The empirical variation in the ensemble's feature layer induced by a perturbation may be judged by δ_{\tilde{T}}, the spacing between bins of the SQ 610 of the feature layer. In other words, bin spacing may be added to the loss function 612 defined by equation (5) as a regularizer, using equation (9):

minL_{class}(θ)+βI(\tilde{X};\tilde{T})+μδ_{\tilde{T}},μ>0,β>0 (9)

Armed with the AIP, machine learning system 104 may implement an MI-based attack detector. For example, machine learning system 104 may be configured to first calculate the MI between the inputs and predictions 618 of a DNN on the training data to establish a threshold 624. It should be noted that at least some loss functions may not require the label. One example of a loss function that does not require the label is the Kullback-Leibler (KL) divergence loss function between the input and its reconstruction. The KL divergence loss function measures the difference between two probability distributions. In the context of machine learning, the KL divergence loss function may be used to measure the difference between the predicted distribution and the true distribution. The KL divergence loss function is typically used for cluster problems. Given a test image, the machine learning system 104 may then compare the MI value for the given image to the above threshold. If the MI value is significantly above or below the threshold, the machine learning system 104 may predict that the input image 608 is adversarial. Evaluation of the results produced by the MI-based attack detector on a variety of datasets and attacks indicate that the machine learning system 104 described herein may effectively detect some adversarial attacks.

Table 1 bellow illustrates robustness comparison of the ensemble approach disclosed herein to vanilla DNNs and prior state of the art in deep ensembles against adversarial attacks. Table 1 compares these approaches on three image classification datasets subject to 4 adversarial attacks. As shown in Table 1, the disclosed ensemble approach is more robust on all shown attacks on all shown datasets.

TABLE 1
Comparison to Vanilla models

| Dataset | Method | Unperturbed | FGM (0.1/0.2/0.3) | PGD (0.1/0.15/0.3) |
|---|---|---|---|---|
| MNIST | Vanilla-LeNet5 | 99.02 | 71.86/27.32/15.88 | 53.2/19.01/0.8 |
| | Ours-LeNet5 (4/1/0/16) | 99.16 | 95.63/89.81/81.83 | 88.01/76.4/34.07 |
| | Ours-LeNet5 (4/1/0/1) | 98.98 | 95.47/89.19/79.33 | 89.30/80.13/44.14 |
| | SQ @ Input - LeNet (16/4/NA/NA) | 99.23 | 95.07/87.16/76.57 | 87.67/75.49/24.42 |
| | | | FGM (0.02/0.04/0.1) | PGD (0.01/0.02/0.1) |
| CIFAR10 | Vanilla-ResNet18 | 91.73 | 22.57/15.84/11.99 | 22.4/7.81/5.54 |
| | Ours-ResNet18 (16/1/10/16) | 85.93 | 55.79/32.99/20.12 | 74.5/53.13/24.79 |
| | Ours-ResNet18 (16/1/10/1) | 78.80 | 69.93/59.14/35.36 | 75.93/70.1/54.1 |
| | SQ @ Input - ResNet18 (16/16/NA/NA) | 86.72 | 51.35/28.12/12.1 | 73.72/48.96/18.81 |
| | | | FGM (0.005/0.01/0.03) | PGD (0.003/0.005/0.01) |
| RESISC45 | Vanilla-ResNet18 | 85.80 | 48.8/33.82/20.7 | 58.17/39.97/20.46 |
| | Ours-ResNet18 (16/1/10/16) | 79.0 | 71.53/58.35/25.62 | 75.8/70.44/57.28 |
| | Ours-ResNet18 (16/1/10/1) | 72.4 | 70.1/65.9/46.10 | 70.41/70.31/66.13 |
| | SQ @ Input - ResNet18 (16/16/NA/NA) | 80.51 | 71.97/55.88/23.13 | 76.95/71.44/54.73 |

TABLE 2
Robustness comparison to ADP, Model used is ResNet-18

| Dataset | Ensemble Methods | Unperturbed | FGM (0.1/0.2) | PGD (0.1/0.15) |
|---|---|---|---|---|
| MNIST | ADP-baseline | NA | 78.3/21.5 | 50.7/6.3 |
| | ADP | NA | 96.3/52.8 | 82.8/41.0 |
| | Ours (4/1/10/16) | 99.53 | 98.41/91.85 | 97.09/89.53 |
| | Ours (4/1/10/1) | 99.53 | 98.43/92.31 | 97.38/93.08 |
| | | | FGM (0.02/0.04) | PGD (0.01/0.02) |
| CIFAR10 | ADP-baseline | NA | 36.5/19.4 | 23.6/6.6 |
| | ADP | NA | 61.7/46.2 | 48.4/30.4 |
| | Ours (16/1/10/16) | 85.93 | 55.79/32.99 | 74.5/53.13 |
| | Ours (16/1/10/1) | 78.80 | 69.93/56.14 | 75.93/70.1 |

TABLE 3
Robustness comparison to EMPIR, Model
MNISTConv for CIFARConv for CIFAR10

| Dataset | Ensemble Methods | Unperturbed | FGM (0.3) | PGD (0.3) |
|---|---|---|---|---|
| MNIST | EMPIR-baseline | 98.87 | 14.32 | 0.77 |
| | EMPIR | 98.89 | 67.06 | 17.51 |
| | Ours (16/1/5/16) | 99.33 | 84.63 | 38.33 |
| | Ours (16/1/5/1) | 99.09 | 82.56 | 27.94 |
| | | | FGM (0.1) | PGD (0.1) |
| CIFAR10 | EMPIR-baseline | 74.54 | 10.28 | 10.69 |
| | EMPIR | 72.56 | 20.45 | 13.55 |
| | Ours (16/0/5/16) | 75.87 | 15.1 | 21.82 |
| | Ours (16/0/5/1) | 65.27 | 28.77 | 50.1 |

In Table 1, Fast Gradient Method (FGM), Projected Gradient Descent (PGD), Patch and square represent different types of adversarial attacks. FGM is a technique for improving the fairness of machine learning models. FGM works by iteratively perturbing the input data in a way that preserves the original label but reduces the unfairness of the model's predictions. For example, the FGM algorithm may work as follows: 1) Start with a set of input data and a machine learning model; 2) Calculate the gradient of the model's inverse-loss function with respect to the input data; 3) Perturb the input data in the direction of the gradient. PGD works by iteratively generating adversarial examples that are close to the original input data, but that cause the model to make incorrect predictions. The PGD algorithm may work as follows: 1)Start with a set of input data and a machine learning model; 2) Calculate the gradient of the model's inverse-loss function with respect to the input data; 3) Generate an adversarial example by adding a small perturbation to the input data in the direction of the gradient; 4) Project the adversarial example back onto the feasible space; 5) Repeat steps 2-4 until an adversarial example is found.

In addition, Table 1 illustrates comparison of different networks and different datasets. LeNet5 is a convolutional neural network (CNN) that is typically used for image classification. The network consists of 7 layers, including 2 convolutional layers, 2 pooling layers, and 3 fully connected layers. The convolutional layers use 5×5 filters, and the pooling layers use 2×2 max pooling. The fully connected layers have 120, 84, and 10 neurons, respectively. ResNet 18 is a deep CNN, with 18 layers, and it was designed to address the problem of vanishing gradients in very deep CNNs. ResNet 18 addresses the vanishing gradient problem by using a technique called residual connections. Residual connections are shortcuts that allow the gradients to flow through the network more easily. Residual connections make it easier for the network to learn, and they also help to prevent overfitting.

The MNIST dataset is a dataset used for evaluating the performance of machine learning models for image classification. The dataset consists of 60,000 training images and 10,000 test images, each of which is a 28×28 grayscale image of a handwritten digit. The labels for the images are the digits that they represent. CIFAR10 is a dataset of 60,000 32×32 color images in 10 classes, with 6,000 images per class. The CIFAR10 dataset is a popular benchmark for evaluating the performance of machine learning models for image classification. The dataset is relatively small, which makes it easy to work with, but it is still challenging enough to provide a good indication of the performance of a model. RESISC 45 is a dataset of remote sensing images for scene classification. The dataset consists of 31,500 RGB images of size 256×256 divided into 45 scene classes, each containing 700 images.

Tables 2 and 3 above illustrate robustness comparison of the ensemble approach disclosed herein to ADP and EMPIR using the same datasets.

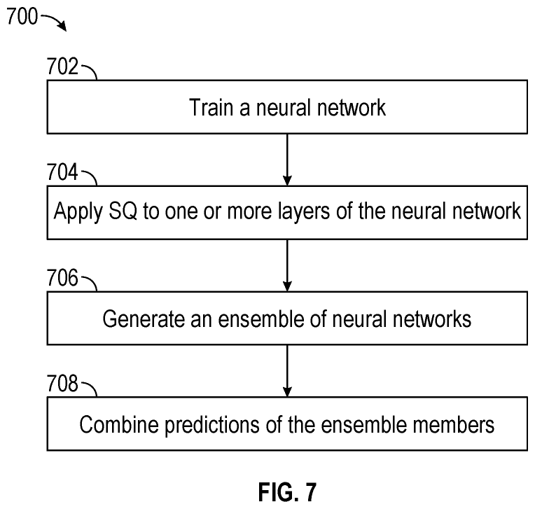

FIG. 7 is a flowchart illustrating an example mode of operation for a machine learning system, according to techniques described in this disclosure. Although described with respect to computing system 100 of FIG. 1 having processing circuitry 143 that executes machine learning system 104, mode of operation 700 may be performed by a computation system with respect to other examples of machine learning systems described herein.

In mode of operation 700, processing circuitry 143 executes machine learning system 104. Machine learning system 104 may train a neural network 105 of the machine learning system 104 using a first input dataset (702). In an aspect, the neural network 105 may comprise a pre-trained model. Machine learning system 104 may apply stochastic quantization to one or more layers 108 of neural network 106 (704). Machine learning system 104 may next generate, using neural network 105, an ensemble of neural networks having a plurality of quantized members that are neural networks 106A-106M (706). Having had SQ applied, at least one of weights or activations of each of the plurality of quantized members 106A-106M have different precision. As noted above, the ensembles of quantized DNNs that are trained using the disclosed approach are more robust to adversarial attacks than single DNNs. The diversity of the ensemble may be quantified using information theory.

Machine learning system 104 may combine predictions of the plurality of quantized members 106A-106M of the ensemble to improve the overall accuracy of the system in detecting one or more adversarial attacks (708). For example, since different neural networks 106A-106M may have different weights, these neural networks 106A-106M may make different predictions on new data.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method comprising:
training a neural network using training data;
applying stochastic quantization to one or more layers of the neural network;
generating, using the trained neural network, an ensemble of neural networks having a plurality of quantized members, wherein at least one of weights or activations of each of the plurality of quantized members have different bit precision; and
combining predictions of the plurality of quantized members of the ensemble to detect one or more adversarial attacks and/or determine performance of the ensemble of neural networks.

2. The method of claim 1, wherein applying stochastic quantization to one or more layers of the neural network further comprises:
applying stochastic quantization to an input layer of the neural network;
extracting one or more features from one or more layers of the neural network; and
applying stochastic quantization to the one or more layers of the neural network.

3. The method of claim 2, wherein the plurality of ensemble members have diversity with regard to sensitivity to changes in the input layer.

4. The method of claim 1, further comprising applying regularization to the weights of at least one of the plurality of quantized members.

5. The method of claim 4, wherein applying regularization further comprises applying mutual information (MI) regularization using the training data.

6. The method of claim 5, wherein the one or more adversarial attacks are detected by:
calculating, using the training data, a first MI value between inputs and outputs of one of the plurality of the ensemble members to establish a threshold;
calculating an absolute value of a second MI for an input;
comparing the calculated absolute value of the second MI with the established threshold; and
predicting that the input is adversarial if the calculated absolute value of the second MI is above the established threshold.

7. The method of claim 5, wherein applying regularization further comprises applying the MI regularization using adversarial attacks generated from the training data.

8. The method of claim 4, wherein applying regularization further comprises applying Lipschitz regularization.

9. The method of claim 1, wherein the ensemble of neural networks comprises a trained federated learning ensemble.

10. A computing system comprising:
an input device configured to receive training data;
processing circuitry and memory for executing a machine learning system,
wherein the machine learning system is configured to:
train a neural network using the training data;
apply stochastic quantization to one or more layers of the neural network;
generate, using the trained neural network, an ensemble of neural networks having a plurality of quantized members, wherein at least one of weights or activations of each of the plurality of quantized members have different bit precision; and
combine predictions of the plurality of quantized members of the ensemble to detect one or more adversarial attacks and/or determine performance of the ensemble of neural networks; and
an output device configured to output the predictions of the plurality of quantized members.

11. The computing system of claim 10, wherein the machine learning system configured to apply stochastic quantization to one or more layers of the neural network is further configured to:
apply stochastic quantization to an input layer of the neural network;
extract one or more features from one or more layers of the neural network; and
apply stochastic quantization to the one or more layers of the neural network.

12. The computing system of claim 11, wherein the plurality of ensemble members have diversity with regard to sensitivity to changes in the input layer.

13. The computing system of claim 10, wherein the machine learning system is further configured to apply regularization to the weights of at least one of the plurality of quantized members.

14. The computing system of claim 13, wherein the machine learning system configured to apply regularization is further configured to apply mutual information (MI) regularization using the training data.

15. The computing system of claim 14, wherein the machine learning system configured to detect one or more adversarial attacks is further configured to:
calculate, using the training data, a first MI value between inputs and outputs of one of the plurality of the ensemble members to establish a threshold;
calculate an absolute value of a second MI for an input;
compare the calculated absolute value of the second MI with the established threshold; and
predict that the input is adversarial if the calculated absolute value of the second MI is above the established threshold.

16. The computing system of claim 14, wherein the machine learning system configured to apply regularization is further configured to apply the MI regularization using adversarial attacks generated from the training data.

17. The computing system of claim 13, wherein the machine learning system configured to apply regularization is further configured to apply Lipschitz regularization.

18. The computing system of claim 10, wherein the ensemble of neural networks comprises a trained federated learning ensemble.

19. Non-transitory computer-readable media comprising machine readable instructions for configuring processing circuitry to:
train a neural network using training data;
apply stochastic quantization to one or more layers of the neural network;
generate, using the trained neural network, an ensemble of neural networks having a plurality of quantized members, wherein at least one of weights or activations of each of the plurality of quantized members have different bit precision; and
combine predictions of the plurality of quantized members of the ensemble to detect one or more adversarial attacks and/or determine performance of the ensemble of neural networks.

20. The non-transitory computer-readable media of claim 19, wherein the instructions to apply stochastic quantization to one or more layers of the neural network further comprise instructions to:
apply stochastic quantization to an input layer of the neural network;
extract one or more features from one or more layers of the neural network; and
apply stochastic quantization to the one or more layers of the neural network.
